(19) United States
(12) Patent Application Publication
(10) Pub. No.: US 2026/0159247 A1
(43) Pub. Date: Jun. 11, 2026

(54) System for recording skydiver exit location, its distance from current aircraft location and an indication of status of establishing adequate separation between multiple skydive groups in freefall who have exited from the same aircraft

(71) Applicant: Benjamin Adepoju, Aurora, CO (US)

(72) Inventor: Benjamin Adepoju, Aurora, CO (US)

(21) Appl. No.: 18/969,679

(22) Filed: Dec. 5, 2024

(51) Int. Cl. B64D 45/00; A63G 31/00; B64D 47/08

(52) U.S. Cl. CPC B64D 45/00; A63G 31/00; B64D 47/08; A63G 2031/005; B64D 2045/007

(57) ABSTRACT

A system and process of reliably noting exit locations of skydive groups from an aircraft, tracking aircraft distance from that point, and indicating to aircraft occupants when a predetermined separation distance has been established and continuously maintained between the aircraft and the last recorded exit location as it continues on its jumprun.

A system for recording skydiver exit location, its distance from current aircraft location and an indication of status of establishing adequate separation between multiple skydive groups in freefall who have exited from the same aircraft

### BACKGROUND OF THE INVENTION

Skydiving is an activity in which individuals exit an aircraft in flight, typically adorning a parachute system. Individuals partaking in the activity are called skydivers. While a flight carrying skydivers to exit altitude is often referred to as a “load”. When at the determined exit altitude, the aircraft maneuvers to fly a path called “jump run” on which skydivers are cleared to exit the aircraft.

Skydivers on a load exit the aircraft in groups—with the possibility of a one person group. Factors such as wind and skydive movement direction can contribute to the risk of collision in freefall, during parachute deployment, and even during parachute flight.

To mitigate the risks of collisions, most skydive planes are equipped with a speed chart indicating how long the next exiting group should delay before exiting the aircraft. The charts often depict a table mapping the aircraft's ground speed to a number of seconds which should be delayed to create a separation of a thousand feet across the ground.

For the remainder of this document, the invention could summarily be referred to as “jump runner” or the “jump runner system”

### SUMMARY OF THE INVENTION

This invention provides a system of reliably informing occupants of a skydiving aircraft of the aircrafts ground speed at all times during a flight conducting a skydiving operation. More importantly, it would serve as a tool and process facilitator for tracking groups of skydivers exiting the aircraft, their exit position in space, and indication of a future point in time when enough space (exit separation) has been achieved to significantly decrease the risks of collisions between individuals during a skydive.

The invention is designed to minimize errors due to human perception, human counting pace, and variations in aircraft ground speed as it moves during the jump run. The invented system ensures accurate information through location awareness checks multiple times a second in comparison to indicated and detect exit points of skydiving groups. Upon detection of the establishment of a specified separation distance between the previous exit group and the skydiving aircraft, the system indicates the update to the occupants of the aircraft through means including visual, audio and haptic feedback.

### BRIEF DESCRIPTION OF DRAWINGS

FIG. 1 Depicts the core of the jump run separation apparatus. It consists of a tablet device and a status light device. These are mounted at a visible location around the jump exit of the aircraft

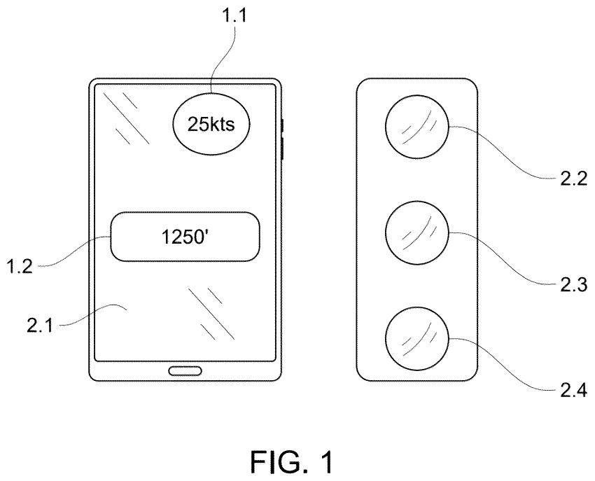

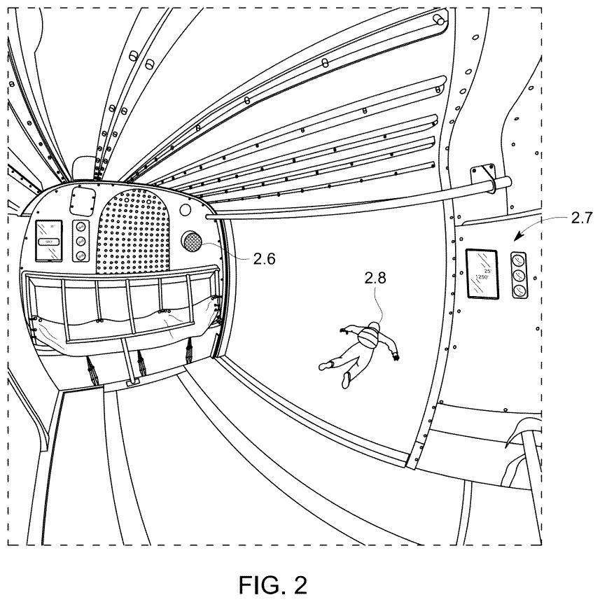

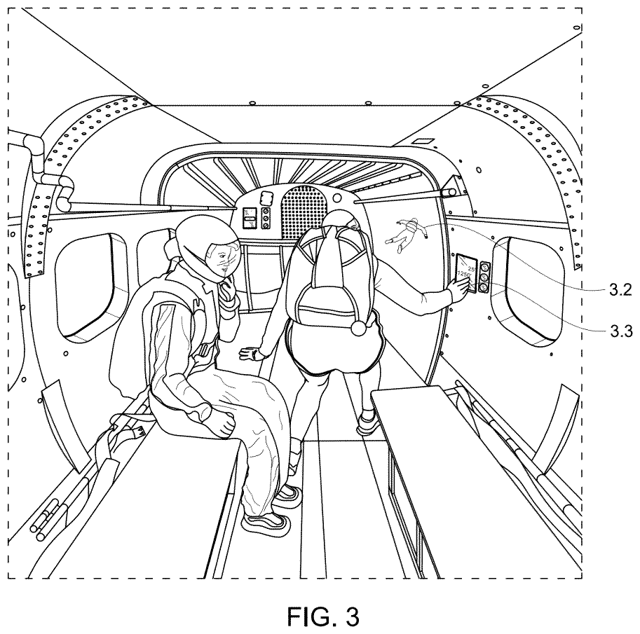

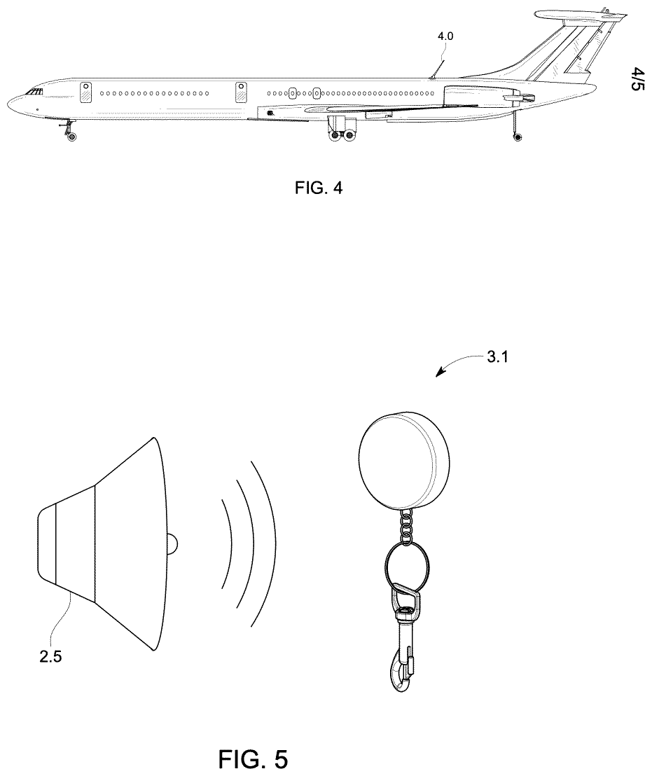

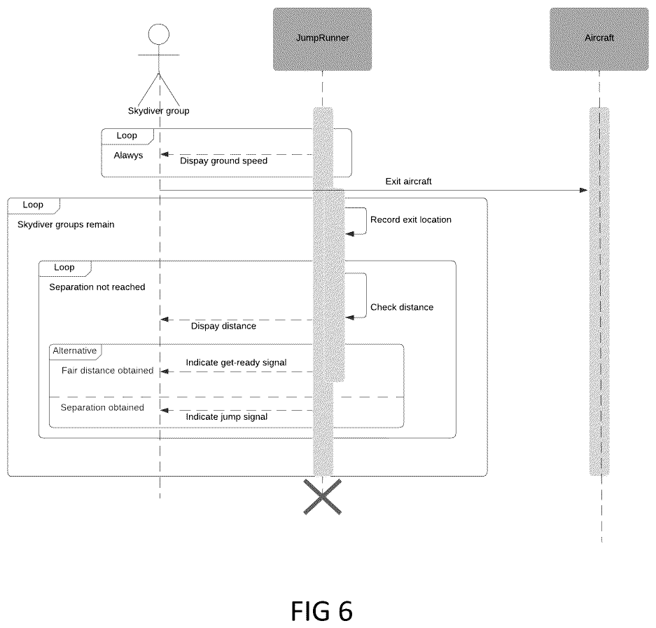

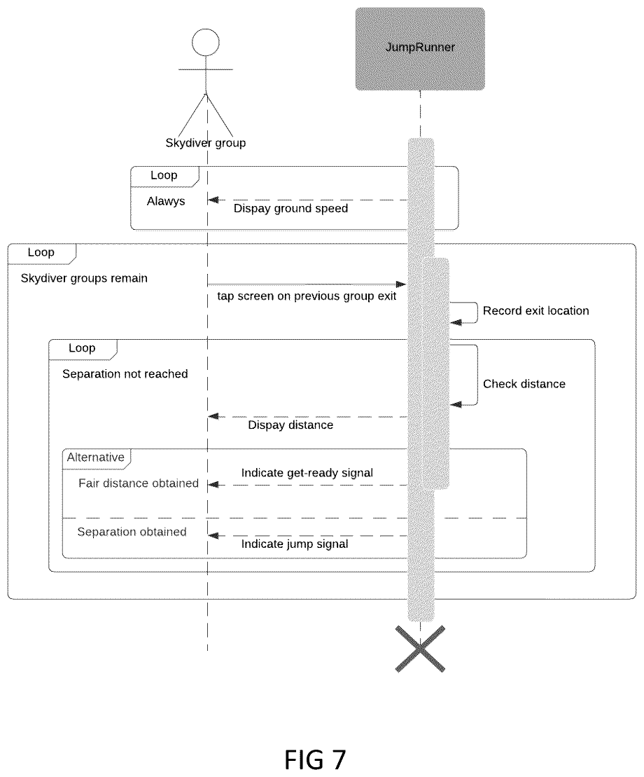

1.1 indicates the aircraft's airspeed in any desired speed unit.

1.2 indicates a straight line distance from the tablet device's current location—also the aircraft's location—to the location of the last recorded jump group exit from the aircraft.

2.1 Is the screen background displayed in sync with the status light indicator. The color of 2.1 would mirror the illuminated light of either 2.2, 2.3, or 2.4

2.2 is a Red light illuminated to indicate that not enough separation has been established between the last recorded jumper exit location and the current location of the aircraft. At the same time 2.3 and 2.4 lights are extinguished.

2.3 is an Amber light illuminated to indicate that enough separation has been established between the last recorded jumper exit location and the current aircraft's location—that the next jump group can safely and efficiently proceed with setting up for an exit from the aircraft. At the same time 2.2 and 2.4 lights are extinguished.

2.4 is a Green light illuminated to indicate that the distance between the aircraft's current location and the last recorded jump exit location is at or greater than a specified distance preconfigured on the device. At the same time 2.2 and 2.3 lights are extinguished.

FIG. 2 Depicts a jumper exiting the aircraft. 2.6 depicts a high pitched speaker that serves as a peripheral of the jump runner system (2.7).

When the distance between the aircraft and the last recorded jump exit location has met the predetermined separation criteria, the speaker (2.6) beeps at the same time the background on the screen and light indicator on the jump separator (2.7) change to illuminate a green color.

Skydive jumper (2.8) exits the aircraft after positive indication from 2.6 and Color indicators on 2.7

FIG. 3 illustrates the detection and registering of an exit jump location.

(FIG. 5, 3.1) is a location beacon that is proximity sensed by Jump separator.

Skydive jumper (3.2) has exited the aircraft with (FIG. 5, 3.1) on their person. Jump separator detects the rapid decrease in proximity between itself and 3.1 and registers and records a jump exit location.

In the absence of 3.1 during a skydive operation, any remaining individual on the aircraft can tap the screen of the jump runner system (3.3) to register and record a jump exit location.

In either case [19] or [20] above, the background (2.1) and status light (2.2) are illuminated Red.

When enough separation is established between the aircraft and the recorded exit location, events in the scene in FIG. 2 are repeated.

FIG. 4 depicts a generic aircraft that can be used for skydive jump operations outfitted with an Antenna (4.0) to augment GPS signals for Jump Runner's location awareness

FIG. 5 depicts peripheral devices for automating location awareness and jump separation feedback

2.5 is a high pitched speaker that would beep on establishment of adequate jump separation

3.1 is a location beacon that is used by Jump runner's proximity sensing capabilities. It is worn by a skydive jumper and with them at all times of the jump operation. This device when separated within a configured distance from the jump runner—by virtue of the skydive jumper exiting the aircraft-facilitates the detection of a skydive exit from the aircraft and the location recorded.

FIG. 6 Sequence diagram depicting events as the system automatically detects a skydiver's exit from the aircraft and updates relevant data to occupants.

FIG. 7 Sequence diagram depicting events and actions between human and the system as involving manual one tap interaction to manually register another skydiver's exit from the aircraft.

### DETAILED DESCRIPTION OF THE INVENTION

The system provides a secure point for tracking skydivers' jump exit locations, the skydive aircraft's location, the dynamic distance between the aircraft's location and the recorded skydive exit locations and provides visual, audio and haptic feedback allowing skydiver occupants of an aircraft to know how fast the aircraft is flying, how far away it is from the last recorded skydiver jump exit, when they may prepare to exit the aircraft and eventually when it is considered safe for them to exit the aircraft based on preconfigured figures for distance preferred by stakeholders for the establishment of adequate separation of multiple skydiver groups in freefall after exiting the same aircraft.

The invention is implemented as a composite software-hardware product and a process bridging the product's operation and current skydive operations. At its core, it's a software application deployed on a touchscreen device that's designed to be automatically location aware and functionally one-touch interactive with any human on board the skydive aircraft. This core unit is intended to be mounted and become a permanent fixture on the interior of a skydive aircraft with an independent power line connecting itself to the aircraft's avionics.

The core unit presents a touchscreen user interface that presents and constantly updates the aircraft's groundspeed, GPS satellite connection count, number of skydive jump exits recorded on the jump run, and the straight line distance between the aircraft and the last recorded skydive exit location. The touchscreen background's color is dynamically updated to a color that indicates exit separation status. By default, there are three possible background colors indicating statuses that imply the following:

TABLE 1
Breakdown of possible jump statuses and their meaning

| Color | Status | Meaning |
|---|---|---|
| Red | Not-Clear | Jump run hasn't commenced or not enough separation has |
| | | been established between the aircraft and the last |
| | | skydiver jumper that a following safe skydive can |
| | | commence |
| Amber | Not-Clear, Ok to | Not enough separation has been established between the |
| | setup | aircraft and the last recorded exit location of a |
| | | skydiver from that aircraft; however enough distance |
| | | has been established that it is optimal for efficiency's |
| | | sake to begin preparation and setup for the next |
| | | skydive exit from the aircraft |
| Green | Cleared to jump | The preconfigured separation distance has been |
| | | established between the aircraft and the last |
| | | recorded skydive exit location and it is inferred that it |
| | | is safe to exit the aircraft. |

The system leverages technologies including the Global Positioning System (GPS) and wireless beacons that allow it maintain geographic location awareness and skydive jumper proximity to itself. GPS is used to independently record skydive exit locations and constantly track the aircraft's location through space while continuously measuring the distance between (separation). As all skydivers on the skydive load all begin their skydive on the same aircraft, this measured distance translates into a basis for determining skydive exit separation among the potential numerous skydive groups onboard the aircraft.

At least one individual from each skydive group may also attach a wireless location beacon on their person, skydive parachute system or carry it in a secured pocket. The beacon is also integrated into the core unit, facilitating its ability to automatically detect the exit and separation of a group of skydivers from the aircraft.

Another method of automatic detection of skydiver exit from the aircraft is via optical monitoring. At least one set of high definition cameras mounted on the interior and exterior of the aircraft to completely cover the exit threshold of the aircraft (e.g door, ramp) in its field of view. Through artificial intelligence, the core of the system is able to detect the presence of human skydivers as they approach, position and set up themselves and eventually depart the aircraft through the door or ramp threshold.

In the absence of the two previous components allowing automatic skydive exit detection, any remaining occupants of the aircraft after the event of a skydive jump exit may touch the system's touch screen with one tap to manually register and record a skydive jump exit and its location in space.

Additional peripherals include a speaker device that can be integrated via a wired or wireless medium to the core unit to provide an audio indication of the jump status to occupants of the aircraft. A three light indicator module is also provided to augment the visual indication of the possible jump statuses in table-1 based on all data connected and processed by the core unit. At least one individual from each skydive group may also attach or carry a secondary beacon device that serves as a receiver for haptic indication of the current jump status. An antenna is also mounted on the interior or exterior of the aircraft to maximize reception between the core unit and GPS satellites in space with the integration facilitated through a wired or wireless medium.

1. A system for recording skydiver exit location, its distance from current aircraft location and an indication of status of establishing adequate distance separation between multiple skydive groups in freefall.

2. The system noted in claim 1 automatically detects a skydive jumper's exit from the aircraft.

3. The system noted in claim 1 manually registers-through human input-a skydive jumper's exit from the aircraft.

4. The system noted in claim 1 is configured with a predetermined distance number and indicates via visual and audio feedback that a predetermined separation distance has been established between a skydiving aircraft and a recorded location of a prior skydive jumper's exit from the aircraft.

5. The system noted in claim 1 is in a form factor that comprises a touchscreen tablet/handphone device, a 3 light indicator peripheral, and a speaker.

6. The parts of the system in claim 1 that are highlighted in claim 4 are mounted on the interior of a skydive aircraft close to the exit door or ramp for optimal exposure and visibility to skydivers.

7. The system in claim 1 is further comprised of high definition cameras mounted in such a way to cover the exit threshold (e.g door, ramp) of an aircraft in its field of view-facilitating automatic detection of skydivers and their exits from the aircraft.

8. The system in claim 1 is further comprised of multiple wireless locator beacons to be worn by skydiving individuals to facilitate automatic detection of a skydivers' exit and separation from the aircraft.

9. The system in claim 1 is further comprised of a pressure mat laid along the exit threshold (e.g. door, ramp) of the aircraft and is used to detect weight dynamics of individuals as they position themselves and eventually exit the aircraft and as such automatically detects a skydiver's exit jump from the aircraft.

10. The system in claim 1 is further comprised of wired/wireless antennas that may be mounted on the interior or exterior of the aircraft to augment reception between itself and satellites used in establishing its location in space.

11. The system in claim 1 is further comprised of multiple wireless haptic beacons that are carried or worn by individual skydiver individuals.

12. The system noted in claim 1 can be configured to be activated remotely by the pilot of the jump aircraft which indicates the first jump exit clearance of the jump run.

13. The system noted in claim 1 supports units of measurement of speed including knots, kilometers per hour, miles per hour, meters per second and feet per second.

14. The system noted in claim 1 supports units of measurement for distance including feet, meters, yards, miles and kilometers.

15. The system noted in claim 1 indicates a ground speed for the aircraft in which it is mounted at all times during a skydive operation.

16. Following the automatic detection or manual registration of a skydiver exit from the aircraft, the system noted in claim 1 indicates the distance between the skydive aircraft it is mounted in and the last recorded skydive exit location on its screen.
